(19) United States
(12) Patent Application Publication
(10) Pub. No.: US 2026/0254529 A1
(43) Pub. Date: Aug. 27, 2026

(54) Energy-Based Generative Models for Fiber-Optic Event Classification

(71) Applicant: NEC Laboratories America, Inc., Princeton, NJ (US)

(72) Inventors: Shaobo Han, Princeton, NJ (US); Ming-Fang Huang, Princeton, NJ (US); Tingfeng Li, Plainsboro, NJ (US); Ting Wang, West Windsor, NJ (US)

(21) Appl. No.: 19/547,672

(22) Filed: Feb. 24, 2026

Related U.S. Application Data
(60) Provisional application No. 63/762,668, filed on Feb. 25, 2025.

(51) Int. Cl. H04B 10/071; G01H 9/00

(52) U.S. Cl. CPC H04B 10/071; G01H 9/004

(57) ABSTRACT

A system and method for distributed fiber-optic sensing (DFOS) event classification utilizing an energy-based generative artificial intelligence model. The method leverages a joint energy-based model (JEM) to ingest both human-annotated labeled sensing data and abundant unlabeled ambient sensing data collected from a DFOS interrogator. The joint energy-based model models the data distribution of high-dimensional spatial-temporal sensing signals, enabling semi-supervised classification that improves generalization, provides calibrated uncertainty estimates, and avoids domain-specific data augmentation constraints. The system further provides a test-time refinement mechanism utilizing Stochastic Gradient Langevin Dynamics (SGLD) updates in the input data space to remove the effects of sensor noise and recover discriminative classification accuracy upon deployment in pre-existing telecom cable networks.

### CROSS REFERENCE TO RELATED APPLICATIONS

This application claims the benefit of U.S. Provisional Patent Application Ser. No. 63/762,668 filed Feb. 25, 2025, the entire contents of which is incorporated by reference as if set forth at length herein.

### FIELD OF THE INVENTION

The present invention relates generally to Distributed Fiber Optic Sensing (DFOS) technology. More particularly, the invention relates to distributed acoustic sensing (DAS) event classification using energy-based generative artificial intelligence models.

### BACKGROUND OF THE INVENTION

In recent years, distributed fiber optic sensing (DFOS) technology has been deployed in numerous applications, including perimeter security, border protection, traffic monitoring, and environmental monitoring. By analyzing various types of optical backscattering signals, DFOS systems can detect physical phenomena such as vibration, strain, and temperature over long distances of optical fiber with fine spatial resolution. These physical data are utilized to extract meaningful events, such as intrusion, construction activities, and vandalism, enabling real-time alerts to prevent early-stage cable damage.

Event identification and classification are typically performed using advanced machine learning technologies, such as deep neural networks. However, several limitations hinder the large-scale deployment of deep learning-based DFOS-AI systems. First, modern deep neural networks tend to be overly confident in their predictions, resulting in poor uncertainty quantification (UQ). Second, training these discriminative models requires a massive database of human-annotated, tagged events, which are tedious and costly to obtain.

While it is possible to boost classifier performance through data augmentation, there is a severely limited set of transformations that are valid without breaking the physical properties of spatial-temporal DFOS signals. Furthermore, purely supervised methods cannot leverage the abundant unlabeled ambient data that becomes readily available once a DFOS interrogator is connected to a fiber route. Existing telecom cables are not designed for sensing, resulting in high noise levels that cause significant drops in feedforward neural network classification performance. Prior solutions utilizing conditional generative adversarial networks (cGAN) to refine simulated data suffer from unstable training and mode collapse issues.

### SUMMARY OF THE INVENTION

An advance in the art is made according to aspects of the present invention directed to a method and system utilizing energy-based generative modeling, specifically a joint energy-based model (JEM), for improving DAS event classification using limited labeled data. By modeling the data distribution of high-dimensional sensing signals, the model can generate realistic sensing signals from noise and provide better-calibrated uncertainty estimates.

The invention leverages unlabeled data to considerably boost discriminative performance without relying on domain-specific data augmentation assumptions heavily tuned for DFOS signals. Additionally, the energy-based model provides an effective mechanism to apply iterative gradient descent (Stochastic Gradient Langevin Dynamics) in the input data space during test-time, which removes the effects of ambient noise and partially recovers classification accuracy. The use of convolutional neural networks, rather than vision transformers, as the potential function ensures stable energy-based training.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative energy-based generative training and inference system and method for DFOS-AI event recognition according to aspects of the present invention.

FIG. 3(A), FIG. 3(B), FIG. 3(C), and FIG. 3(D) show a series of qualitative evaluation of samples generated by the energy-based model at different stages of training for: FIG. 3(A) initialization; FIG. 3(B) mid-training; FIG. 3(C) final, and FIG. 3(D) real DAS dataset for reference. Initially, the generated samples appear as pure noise. As training progresses, discernable patterns emerge, though they remain distinguishable from real DAS data. At the final stage, the generated samples become visually indistinguishable from the real data, all according to aspects of the present invention.

FIG. 4(A) and FIG. 4(B) show a pair of reliability diagrams in which: FIG. 4(A) show supervised learning with only labeled data; and FIG. 4(B) show semi-supervised learning with both labeled data and unlabeled data; all according to aspects of the present disclosure.

FIG. 5 is a graph of Accuracy vs. Proportion of Unlabeled Data illustrating semi-supervised vs. supervised classification, with generative modeling, the amount of unlabeled data translates into boost in discriminative performance according to aspects of the present invention.

FIG. 6 shows robustness to noises by applying SGLD-based refinement during test-time in tabular form according to aspects of the present invention.

FIG. 7 shows our inventive model architecture summarized in tabular form according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

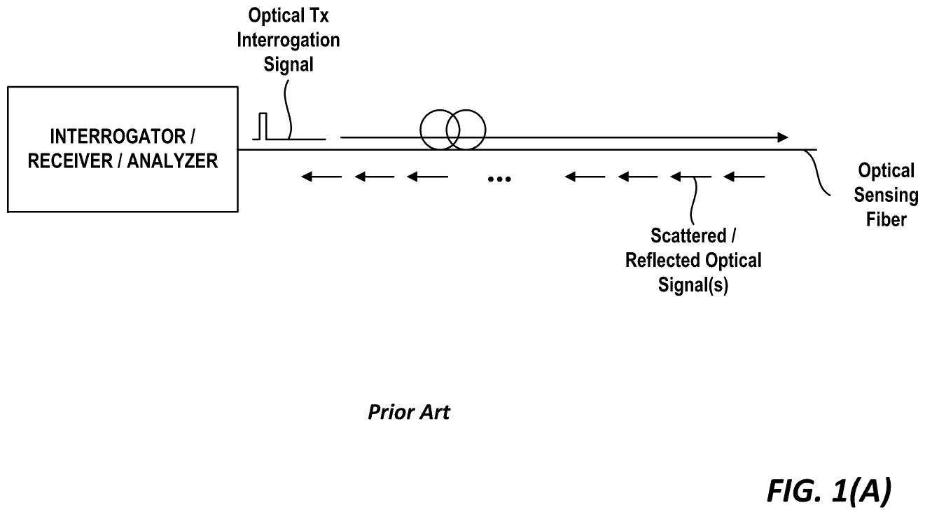

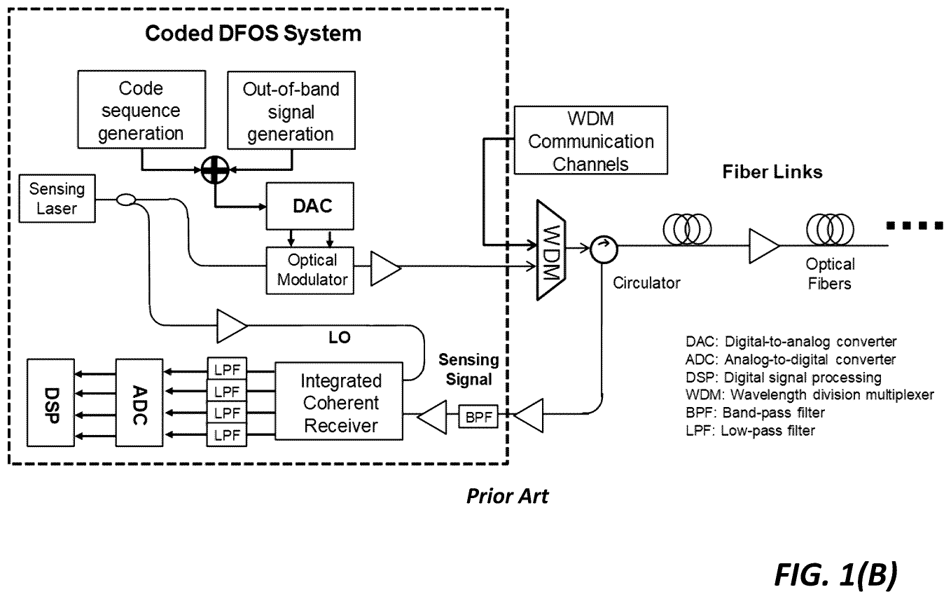

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

We note once again that, distributed fiber optic sensing (DFOS) technology has been used in more and more applications, such as perimeter security, border protection, oil and gas exploration and production, traffic and road monitoring, environment monitoring, natural disaster warning, etc. By analyzing various types of optical backscattering signals (Rayleigh, Brillouin, and Raman), DFOS systems can detect different physical phenomena such as vibration, strain, and temperature over a long distance of optical fiber with fine spatial resolution. These physical data can then be used to extract meaningful events such as intrusion, seismic activity, traffic movement, oil production, construction, etc. The event identification and classification is usually performed using advance machine learning (ML) technologies such as deep neural networks. For example, distributed fiber-optic sensing (DFOS) and machine-learning-based event classification enable protection of telecom facilities by detecting hazardous events, such as construction activities (boring, digging, augering), animal chewing, gunshots, and vandalism, and generating real-time alerts, which allow actions to be taken in a timely manner in preventing cable damage at an early stage.

As deep learning-based DFOS-AI systems are increasingly adopted in real-world DFOS applications, there are several limitations hindering their large-scale deployment we note as follows:
i. For Fiber-Optic Event Classification, it is crucial to have accurate predictions with reliable uncertainty quantification (UQ), allowing for appropriate human intervention when uncertainty is high.
ii. Modern deep neural networks are increasingly entrusted to make complex decisions in DFOS-AI systems. However, they tend to be overly confident in their predictions, and training such models requires a large database of tagged events, which are tedious and costly to obtain in DFOS.
iii. It is possible to boost the performance of deep learning classifiers through data augmentation and self-supervised learning, but unlike natural images, there is a limited set of transformations that are valid without breaking the physical properties of the spatial-temporal DFOS signals.
iv. Supervised methods cannot leverage the abundant unlabeled data that becomes readily available after connecting a DFOS interrogator to a fiber route.
v. Existing telecom cables are not designed for sensing, and some regions may experience high noise levels. The model prediction of traditional neural network is based on feedforward operations in which noise could cause significant performance drop. There lacks an effective mechanism to apply more computation during test-time to remove the effect of noise, and recover the classification performance.

In a prior work, conditional generative adversarial network (cGAN) was applied to fiber-optic distributed acoustic sensing (DAS) applications within a Sim-to-Real transfer pipeline, where simplified simulated data is refined by the generator to have the features of real field experiment data. Utilizing computer simulations, deep generative models refinement, and fine-tuning with field experimental data leads to significantly improved classification accuracy. However, GAN training could be unstable and suffers from mode collapse issues.

According to the present invention, we use energy-based generative modeling (in particular, joint energy-based model for improving DAS event classification with limited labeled data. By modeling the data distribution of high-dimensional sensing signals, JEM can generate realistic-looking sensing signals from noise and provides better-calibrated uncertainty estimates in classification. During test-time, when the observed sensing data are noisy, energy-based model (EBM) can improve the data quality and classification accuracy by iterative gradient descent in the input data space, starting from the noisy input sample.

As those skilled in the art will understand and appreciate, generative models can generate realistic samples, enriching training datasets and improving classifier generalization, especially in low-data regimes. Besides generating visually appealing sensing images, generative models also have the potential to unlock the use of unlabeled data and improve the classification performance by capturing the underlying structure of data. Compared to generate high-fidelity data to enrich the training dataset, the possibilities of using unlabeled data to improve classification performance, confidence calibration during training, and performance recovery upon noises during test-time, are less explored in the context of DFOS-AI event classification.

The large-scale deployment of discriminative AI systems in real-world DFOS applications has been hindered by a shortage of labeled data. Energy-based generative models on sensing images can help unlock the potential of utilizing unlabeled data for downstream discriminative tasks, improving generalization, uncertainty quantification and noise robustness. These features align with the need for data efficient, reliable, and trustworthy AI in mission-critical telecom applications.
i. We demonstrate that generative modeling help bridge the algorithmic readiness gap in building reliable and generalizable classifiers for practical DFOS applications. Utilizing unlabeled sensing data leads to considerable boost in discriminative performance with the use of our approach.
ii. Generative modeling on unlabeled data also boost in the classifier's calibration in addition to prediction accuracy. This is an important feature for a model to have for DFOS-AI system in real-world deployment, where outputting an incorrect decision can lead to waste of field inspection efforts and upon uncertain cases, the model shall abstain from prediction and defer low confidence samples to human.
iii. Existing telecom cables are not designed for sensing, and some regions may experience high noise levels. The addition of noise causes a significant drop in classification accuracy, but energy-based SGLD refinement can help partially recover it.
iv. In DAS applications, unlabeled data are easier to obtain, which can help shape more meaningful energy landscapes while influencing the classification boundary. In the absence of data augmentation operations heavily tuned for DAS signals, energy-based generative modeling provides a density estimation framework for semi-supervised learning without requiring additional domain-specific assumptions.

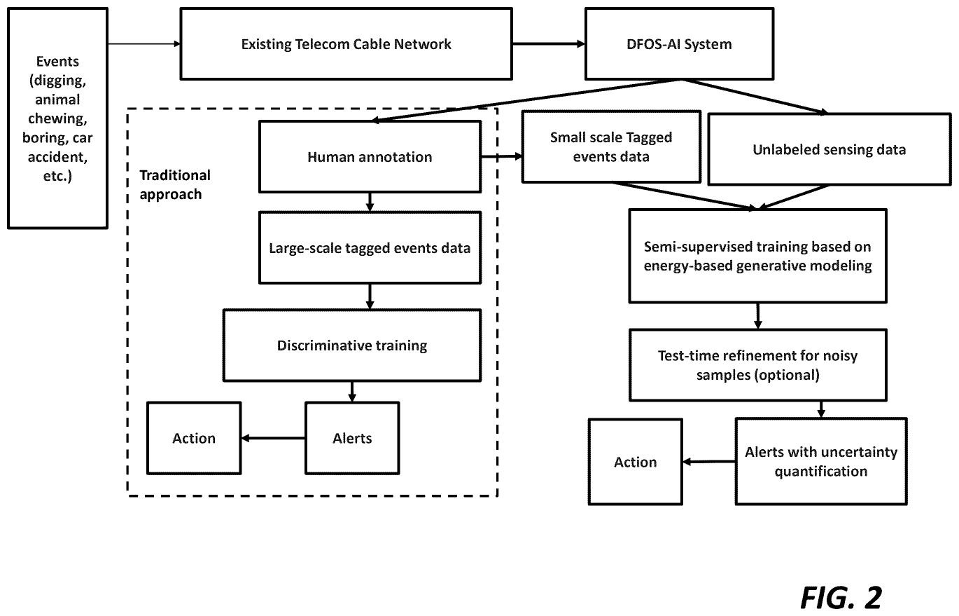

FIG. 2 is a schematic diagram showing an illustrative energy-based generative training and inference system and method for DFOS-AI event recognition according to aspects of the present invention. The dotted-line block covers traditional approach we compare to. During training, our approach only needs a small amount of tagged event data from human annotator, and can utilize abundant unlabeled DFOS sensing data. During test-time, we have the choice of applying a few steps of gradient-based refinement for performance recovery. Finally, the decision making is based on the alerts with calibrated uncertainty estimates.

A step-by-step description of our invention may be understood as follows:
Step 0: Data Collection: Connecting a DFOS interrogator to the cable route and collect ambient data. Human expert provide label for a few events. We evaluate the performance of the proposed model for fiber sensing event classification using field DAS data collected from telecom networks and annotated by human experts. The sensing image dataset contains 16264 samples from 37 event classes, including traffic, digging noise, rolling machine noise, etc.
Step 1: Training: Given a partially labeled dataset D:={L, U}, discriminative models directly learn the conditional distribution p_θ (y|x) of label y given the input x, while the generative approaches model the joint distribution p_θ (x, y) of input data x and label y.

Traditionally, discriminative approaches are favored, as pθ (x) is considered not directly related to the conditional distribution pθ (y|x), which is the primary focus in classification. In the energy-based formulation, both pθ (x, y) and pθ (y|x) can be interpreted as EBM with parameter sharing in the energy functions Eθ (x, y)=−fθ (x)[y] and Eθ (x).

In the JEM model, the data densities are modeled as,

$${p}_{θ} ( y , x ) = \frac{exp ( {f}_{θ} ( x ) [ y ] )}{Z ( θ )} , {p}_{θ} ( x ) = {\sum }_{y} {p}_{θ} ( x , y ) = {\sum }_{y} \frac{exp ( {f}_{θ} ( x ) [ y ] )}{Z ( θ )} ,$$

which induces the conditional distribution via Bayes rule with the normalizing constant Z(θ) canceled out,

$${p}_{θ} ( y \vert x ) = \frac{exp ( {f}_{θ} ( x ) [ y ] )}{{\sum }_{{y}^{′}} exp ( {f}_{θ} ( x ) [ {y}^{′} ] )} .$$

The joint log-likelihood can be factorized as

$$log {p}_{θ} ( x , y ) = log {p}_{θ} ( x ) + log {p}_{θ} ( x \vert x ) ,$$

allowing models to learn from both labeled and unlabeled datasets, where p_θ (y|x) can be optimized in the same way as a typical classifier on labeled dataset L, and p_θ (x) can be optimized as an EBM with energy function

$${E}_{θ} ( x ) = - log ( {\sum }_{y} exp ( {f}_{θ} ( x ) [ y ] ) ) ,$$

on unlabeled dataset U. We adopt the following maximum likelihood estimator,

$${θ}_{graad} = \frac{\partial log {p}_{θ} ( x )}{\partial θ} = {∇}_{θ} {E}_{θ} ( x ) - {∇}_{θ} {E}_{θ} ( {x}_{y} ) , x \sim 𝒰 , {x}_{g} \sim {p}_{θ} ( x ) ,$$

where is sampled from p_θ (x) based on Stochastic Gradient Langevin Dynamics (SGLD),

$${x}_{0} \sim {p}_{θ} ( x ) , {x}_{i + 1} = {x}_{t} - \frac{α}{2} \frac{\partial {E}_{θ} ( {x}_{t} )}{\partial {x}_{i}} + ϵ , ϵ \sim 𝒩 ( 0 , {β}^{2} ) ,$$

where p_θ (x) is a uniform distribution over the input signal space.

### Step 2: Visual Quality Check

We can check quantitative sample quality in a visual Turing test. This is a necessary step to diagnosis of the energy-based training to see what the model has been learn of. We have been noted that convolutional neural network (ConvNets) are easier to train than the vision transformer (ViT) based architecture as the potential function of the energy-based model.

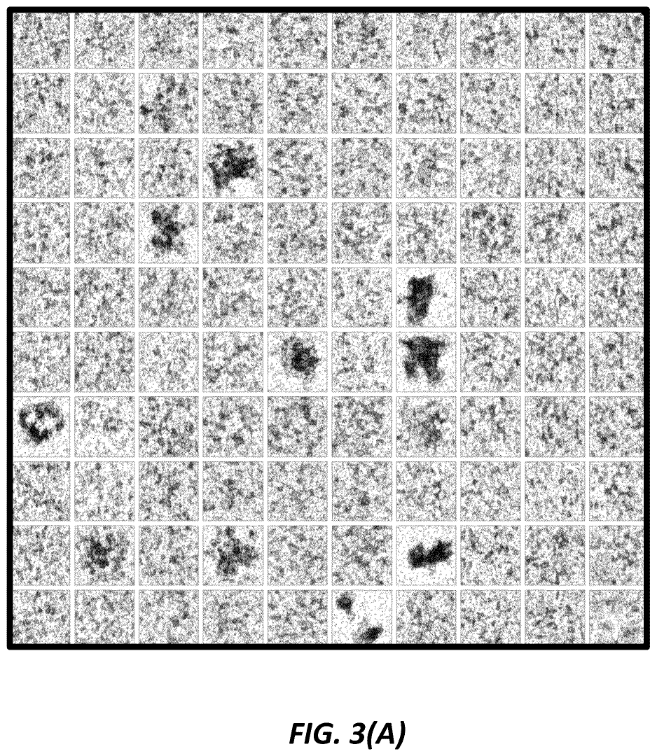

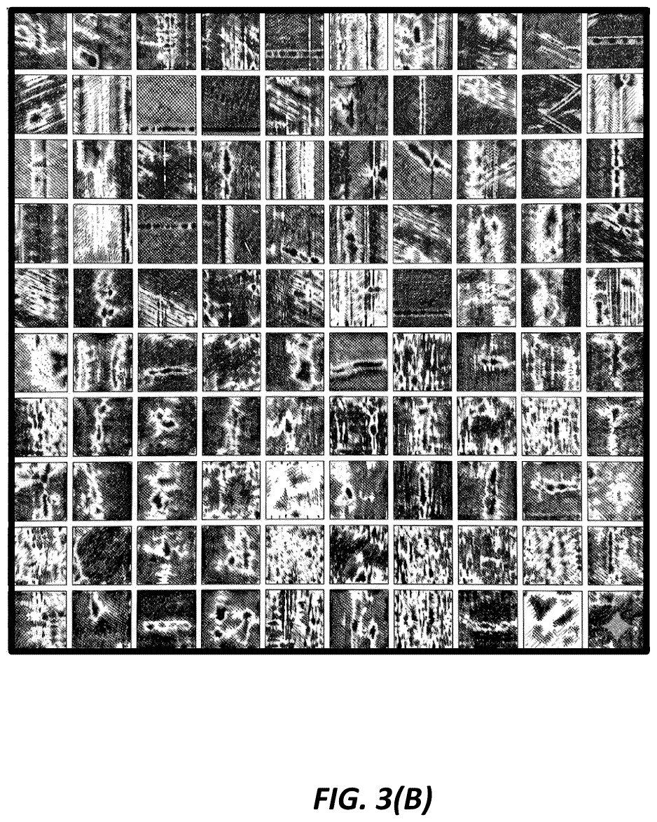

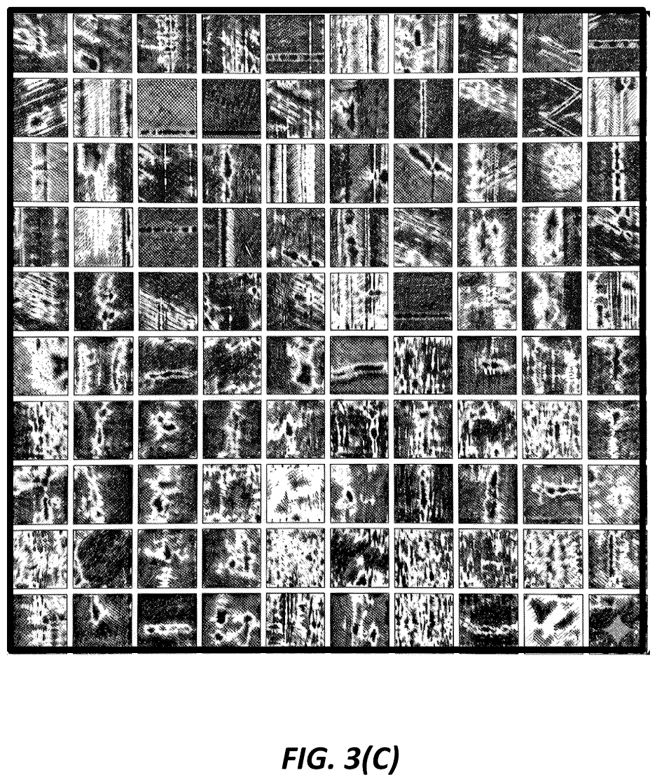

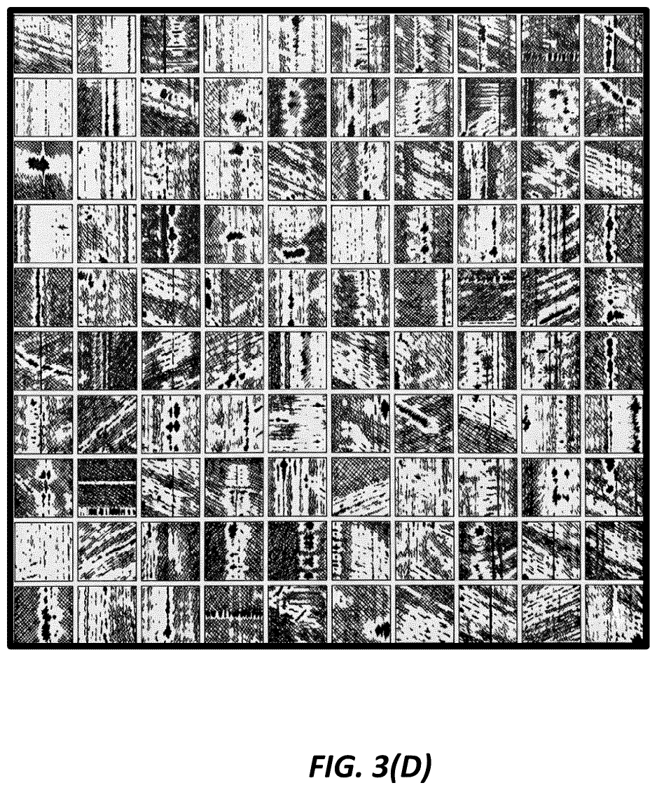

FIG. 3(A), FIG. 3(B), FIG. 3(C), and FIG. 3(D) show a series of qualitative evaluation of samples generated by the energy-based model at different stages of training for: FIG. 3(A) initialization; FIG. 3(B) mid-training; FIG. 3(C) final, and FIG. 3(D) real DAS dataset for reference. Initially, the generated samples appear as pure noise. As training progresses, discernable patterns emerge, though they remain distinguishable from real DAS data. At the final stage, the generated samples become visually indistinguishable from the real data, all according to aspects of the present invention. More particularly, these figures show the quality of unconditional samples drawn from p_θ (x) at different stages of training, compared to realistic cases as a reference.

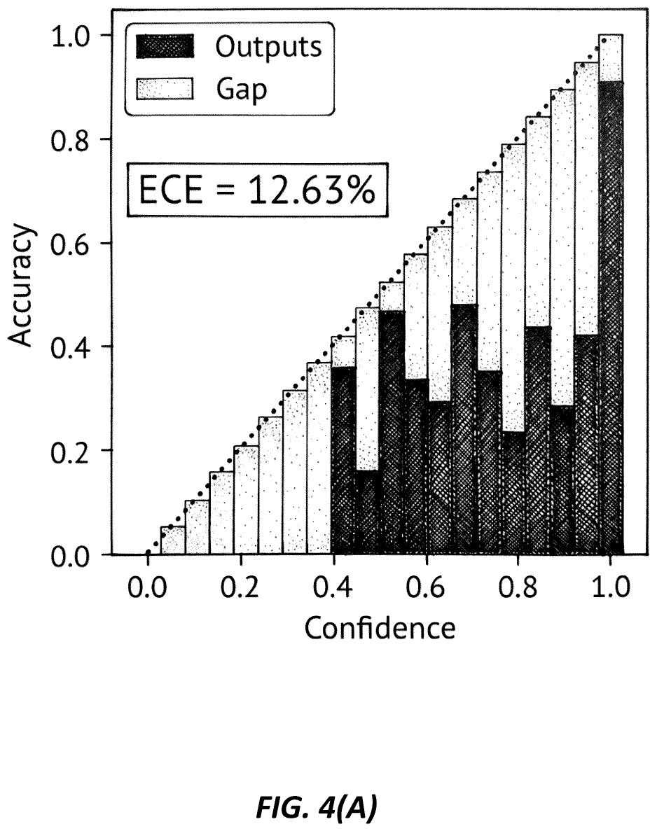

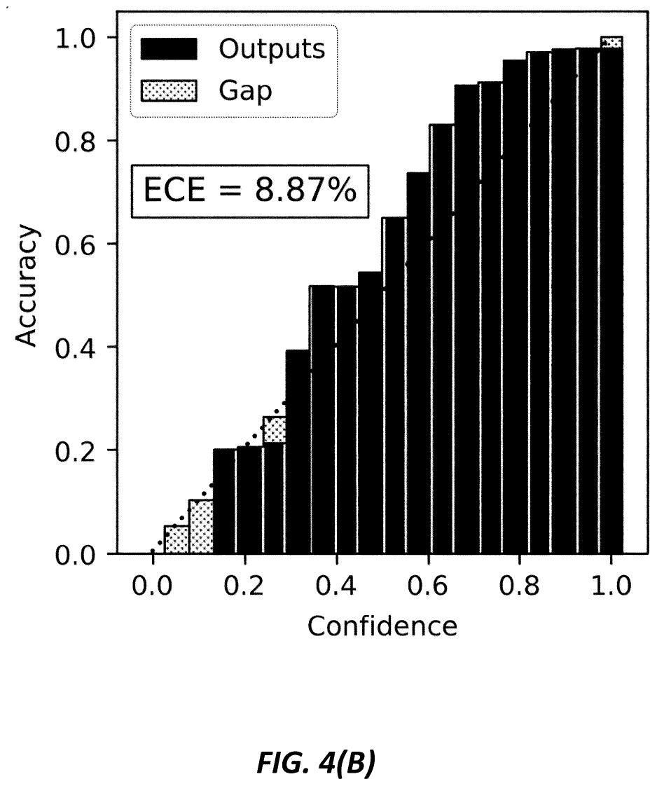

FIG. 4(A) and FIG. 4(B) show a pair of reliability diagrams in which: FIG. 4(A) show supervised learning with only labeled data; and FIG. 4(B) show semi-supervised learning with both labeled data and unlabeled data; all according to aspects of the present disclosure. FIG. 4(A) and FIG. 4(B) use the Expected Calibration Error (ECE) to measure the alignment between model confidence and test accuracy.

FIG. 3(A), FIG. 3(B), FIG. 3(C), and FIG. 3(D) show that the original classifier trained on labeled data tends to be overconfident in its predictions. The same model architecture trained with both labeled and unlabeled data produces much better confidence estimates.

$$ECE = {\sum }_{m = 1}^{M} ( \vert {B}_{m} \vert / n ) \vert acc ( {B}_{m} ) - confidence ( {B}_{m} ) \vert ,$$

where B_m is the set of samples in the m-th bin, n is the total number of samples, M=20.

We limit the model to use 50 labeled samples per class, and a proportion of the 3184 unlabeled samples, ranging from 0% (supervised baseline) to 100% in increments of 20%, for training. The best model is selected using a validation set of 1000 samples.

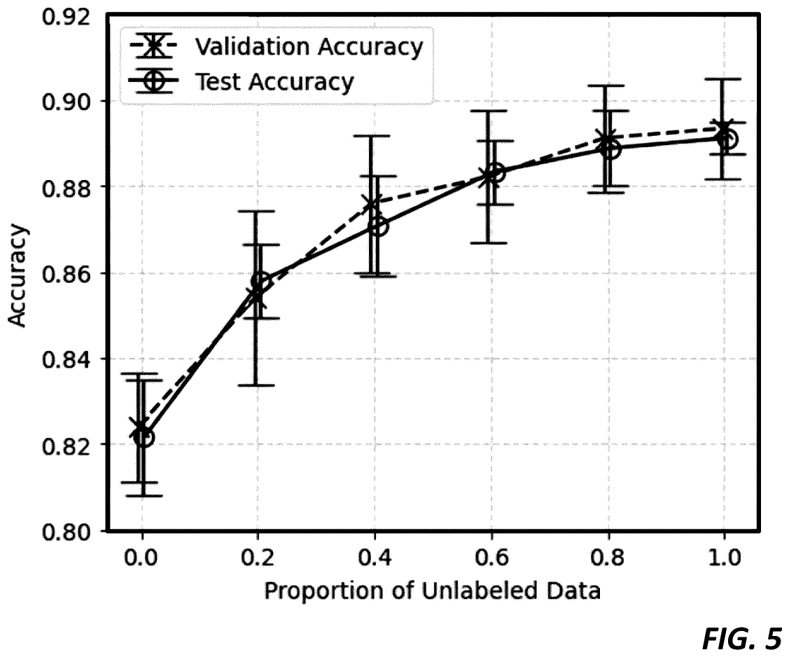

FIG. 5 is a graph of Accuracy vs. Proportion of Unlabeled Data illustrating semi-supervised vs. supervised classification, with generative modeling, the amount of unlabeled data translates into boost in discriminative performance according to aspects of the present invention. FIG. 5 compares classification accuracy between supervised and semi-supervised approaches. Considerable improvement of discriminative performance is achieved from unlabeled data.

### Step 4: Test-Time Refinement for Performance Recovery (Optional):

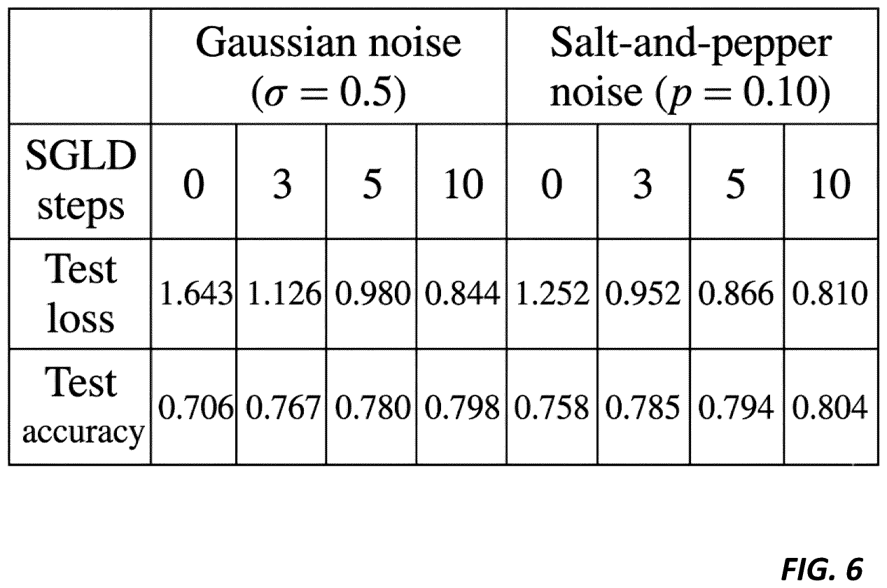

To evaluate noise robustness, we introduce two types of noise into the sensing data, as detailed in FIG. 6, which shows robustness to noises by applying SGLD-based refinement during test-time in tabular form according to aspects of the present invention.

The addition of noise causes a significant drop in classification accuracy, but energy-based SGLD refinement help partially recover it. FIG. 6 shows a gradual decrease in cross-entropy loss and an increase in classification accuracy by 9.2% and 4.6% with 10 SGLD steps.

Additional implementation details: Across all experiments, we use WideResNet-28-10 with no batch normalization as the potential function of the EBM. The sensing images are resized to 32×32 and scaled to [−1, 1] with N (0, 0.03\hat{ }2) Gaussian noise added for stabilizing training. We use Adam optimizer with learning rate 0.0002 and set the number of SGLD steps as 40 with α=1 and β=0.01. For all experiments, we report average metric (e.g., loss, accuracy) across 5 runs.

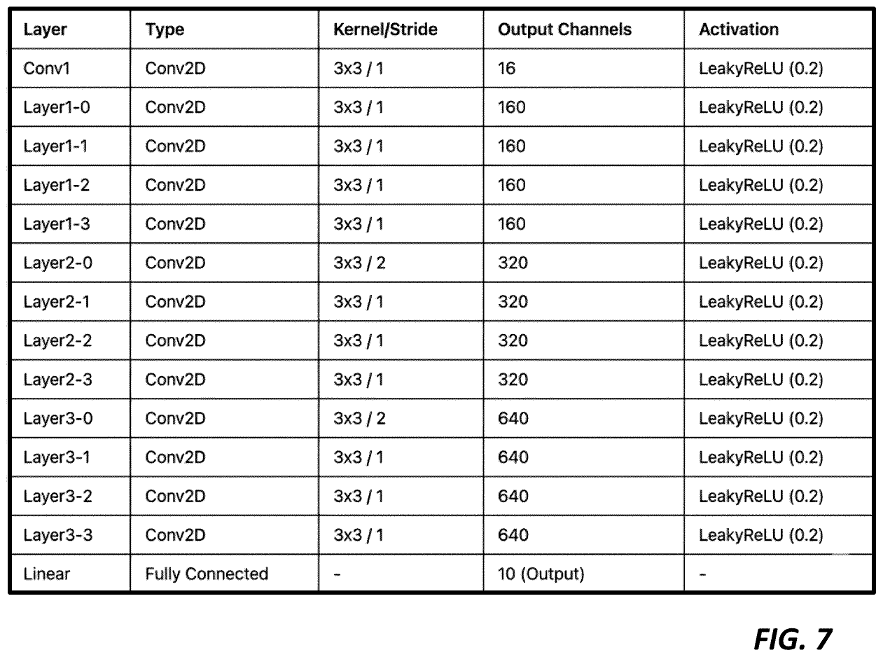

FIG. 7 shows our inventive model architecture summarized in tabular form according to aspects of the present invention.

1. A method for physical event recognition in a distributed fiber-optic sensing (DFOS) system, the method comprising:
receiving unlabeled spatial-temporal sensing data from a distributed fiber optic interrogator connected to an optical fiber route;
receiving a partially labeled dataset of physical sensing events;
training a joint energy-based generative model using both the labeled dataset and the unlabeled spatial-temporal sensing data to model a joint distribution of input signals and corresponding event labels; and
classifying physical events along the optical fiber route utilizing conditional distribution inferences derived from the trained joint energy-based generative model.

2. The method of claim 1, wherein training the joint energy-based generative model improves discriminative classification performance without relying on domain-specific data augmentation assumptions heavily tuned for spatial-temporal DFOS data.

3. The method of claim 1, wherein training the joint energy-based generative model directly improves discriminative classification performance without utilizing generated realistic samples as an intermediate training data interface to re-train the model.

4. The method of claim 1, wherein parameter estimation for the joint energy-based generative model is executed under maximum likelihood estimation utilizing an induced probabilistic framework rather than utilizing adversarial generative network (GAN) training.

5. The method of claim 1, wherein the joint energy-based generative model utilizes a convolutional neural network architecture as a potential function rather than a vision transformer (ViT) architecture.

6. The method of claim 5, wherein the convolutional neural network architecture omits batch normalization layers.

7. The method of claim 1, further comprising: outputting a calibrated confidence score during the classification of physical events; generating an immediate high-risk alert if the confidence score exceeds an upper threshold; and abstaining from prediction and deferring the event to a human operator if the confidence score falls below a lower threshold.

8. The method of claim 1, further comprising applying test-time refinement to an observed noisy sensing signal by performing iterative gradient projection utilizing Stochastic Gradient Langevin Dynamics (SGLD) in an input data space to recover classification performance.

9. A distributed fiber-optic sensing (DFOS) system configured to execute the method of claim 1 to detect and classify telecom infrastructure hazards including construction activities, animal chewing, and vandalism.
